(19) United States
(12) Patent Application Publication
(10) Pub. No.: US 2026/0112510 A1
(43) Pub. Date: Apr. 23, 2026

(54) NUCLEAR FUSION DEVICE AND METHOD FOR CONTROLLING NUCLEAR FUSION INTENSITY

(71) Applicant: SHIHAO CHEN, CHANGCHUN (CN)

(72) Inventor: SHIHAO CHEN, CHANGCHUN (CN)

(21) Appl. No.: 18/924,423

(22) Filed: Oct. 23, 2024

(51) Int. Cl. G21B 3/00

(52) U.S. Cl. CPC G21B 3/006

(57) ABSTRACT

A nuclear fusion device and a method for controlling nuclear fusion intensity are disclosed. The nuclear fusion device includes a nuclear beam generation unit that emits a nuclear beam, a reaction vessel filled with nuclear fusion material, a thermal energy output system and an electrical energy output system that convert the energy produced by the nuclear fusion reaction into thermal energy and electrical energy for output. The reaction vessel receives the nuclear beam, which reacts with the nuclear fusion material inside to produce neutrons, achieving a neutron nuclear fusion cycle reaction and releasing energy. The nuclear beam includes at least one of a triton beam with a single nucleus energy of 50 KeV-1 MeV, a deuteron beam with a single nucleus energy of 100 KeV-5 MeV, and a proton beam with a single nucleus energy of 2-10 MeV; the nuclear fusion material includes polyatomic molecules, which at least include ⁶LiD and ⁷LiD.

### TECHNICAL FIELD

The present application relates to the field of nuclear energy technology, particularly to a nuclear fusion device and a method for controlling nuclear fusion intensity.

### BACKGROUND ART

Nuclear fusion has the potential to generate enormous amounts of energy, but achieving controllable nuclear fusion reactions is extremely challenging. Currently, humans achieve nuclear fusion through hydrogen bombs, which work by using the fission reaction of a uranium bomb to create an instantaneous high temperature and pressure that ignites hydrogen isotopes, resulting in thermonuclear fusion. However, this process involves a sudden explosion that releases a vast amount of energy, is destructive, completely uncontrollable, and not sustainable. The energy produced cannot be recovered or utilized.

According to theoretical calculations in physics, for a nuclear fusion reaction to occur, the product of temperature, density and confinement time must exceed the Lawson criterion. It requires a high temperature of tens of millions or even hundreds of millions of degrees and density for the motion speed of hydrogen isotopic particles to overcome the Coulomb force between atomic nuclei, and hydrogen isotopic particles collide with each other and produce a nuclear fusion reaction with continuous commercial value. Since current nuclear fusion requires temperatures above one hundred million degrees and the Lawson criterion must be met, it is difficult to achieve the controllable nuclear fusion, and achieving controllable nuclear fusion has become an urgent problem to be solved.

### SUMMARY

The purpose of this disclosure is to provide a nuclear fusion device and a method for controlling nuclear fusion intensity, with the aim of achieving controllable nuclear fusion.

The disclosure provides a nuclear fusion device. The nuclear fusion device includes a nuclear beam generation unit that emits nuclear beams, a reaction vessel filled with a nuclear fusion material, a thermal energy output system and an electrical energy output system that converts the energy produced by the nuclear fusion reaction into thermal energy and electrical energy for output respectively. The reaction vessel receives the nuclear beam emitted by the nuclear beam generation unit, the nuclear beam is incident into the reaction vessel and initiates a nuclear fusion reaction with the nuclear fusion material in the reaction vessel to generate neutrons, achieving a neutron nuclear fusion cycle reaction and releasing energy; wherein the nuclear beam includes at least one of a triton beam with a single nucleus energy of 50 KeV-1 MeV, a deuteron beam with a single nucleus energy of 100 KeV-5 MeV, and a proton beam with a single nucleus energy of 2-10 MeV; and the nuclear fusion material includes polyatomic molecules, and the polyatomic molecules at least includes ⁶LiD and ⁷LiD.

Optionally, the wall of the reaction vessel is provided with two layers, namely an inner layer and an outer layer, the inner layer includes a neutron reflection layer, the outer layer includes a neutron absorption layer, the neutron reflection layer includes a ⁹Be layer, and the neutron absorption layer includes a ¹⁰B layer; wherein the thickness of the wall of the reaction vessel is greater than or equal to a thickness required to reduce a kinetic energy of neutrons to 25.3 meV.

Optionally, the polyatomic molecules include ⁶LiD and ⁷LiD, and the weight ratios of ⁶LiD and ⁷LiD in the nuclear fusion material are respectively 30% to 70% and 70% to 30%.

Optionally, the polyatomic molecules include ⁶LiD, ⁷LiD and ⁹Be, and weight ratios of ⁶LiD, ⁷LiD and ⁹Be in the nuclear fusion material are respectively 20% to 60%, 60% to 20%, and 20% to 40%.

Optionally, ⁹Be in the neutron reflection layer has a large reflection section for neutrons, with σ(10 μeV)=120 b; ¹⁰B in the neutron absorption layer has a larger absorption section for neutrons compared to that of ⁹Be in the neutron reflection layer, with σ(10 μeV)=2×10⁵ b.

Optionally, the nuclear beam generation unit includes an ionization chamber and an accelerator; the ionization chamber generates positive ions and transports same to the accelerator, and the positive ions is vertically incident onto the nuclear fusion material by the accelerator; the reaction vessel includes a base plate, the base plate includes a valve, a size of the valve opening is automatically controlled based on input signals; the nuclear fusion device also includes a shallow conduit and a push rod, the shallow conduit is connected to the valve opening, and a solution from the reaction vessel flows through the valve opening into the shallow conduit, and under an action of the push rod, the solution in the shallow conduit flows back into the reaction vessel; an electric heating device is provided under the shallow conduit, and the electric heating device is capable of heating the solidified solution; wherein the solution is the nuclear fusion material in a molten state, and the push rod is made of ⁹Be.

Optionally, the nuclear fusion device includes a temperature sensor, the temperature sensor is provided above the reaction vessel to measure a boiling point of the solution inside the reaction vessel; the temperature sensor is connected to the accelerator and the valve, sends electrical signals to the accelerator and the valve based on comparison results between the boiling point temperature and a preset temperature, controls an amount of the nuclear beam incident into the reaction vessel by the accelerator, or controls the opening or closing of the valve, thereby controlling the intensity and temperature of the nuclear reaction.

Optionally, the nuclear fusion device includes an isolation plate, when the temperature sensor measures a boiling point temperature greater than or equal to the preset temperature, the isolation plate is inserted into the reaction vessel to a predetermined depth, when the temperature sensor measures a boiling point temperature less than the preset temperature, the isolation plate inserted into the reaction vessel is pulled out; wherein the isolation plate is made of ¹⁰B.

The present disclosure also provides a method for controlling nuclear fusion intensity, which is used to control the nuclear fusion intensity in any one of the above-mentioned nuclear fusion devices. The control method includes the following steps:
controlling a nuclear beam generation unit to emit a nuclear beam into a reaction vessel, thereby initiating a nuclear fusion reaction with a nuclear fusion material inside the reaction vessel;
converting energy produced by the nuclear fusion reaction into thermal energy and electrical energy for output.

Optionally, the nuclear fusion device includes a temperature sensor and an isolation plate, and the step of controlling a nuclear beam generation unit to emit a nuclear beam into a reaction vessel, thereby initiating a nuclear fusion reaction with a nuclear fusion material inside the reaction vessel includes:
measuring a boiling point temperature of a solution inside the reaction vessel by the temperature sensor;
comparing the boiling point temperature with a preset temperature, when the boiling point temperature measured by the temperature sensor is greater than or equal to the preset temperature, sending an electrical signal to the accelerator and the valve, shutting down the accelerator, or controlling the valve to close, or controlling the isolation plate to be inserted to a predetermined depth, thereby reducing the intensity and temperature of the nuclear reaction; when the boiling point temperature measured by the temperature sensor is less than the preset temperature, sending an electrical signal to the accelerator and the valve, turning on the accelerator, increasing the amount of the nuclear beam entering the reaction vessel, or controlling the valve to open, or pulling out the isolation plate inserted to a predetermined depth, thereby reducing the intensity and temperature of the nuclear reaction.

Compared to the scheme of using monoatomic molecules for nuclear fusion, this disclosure uses polyatomic molecules for nuclear fusion. The nuclear beam generation unit can control the amount of nuclear beams emitted into the reaction vessel, the polyatomic molecules in the reaction vessel include at least ⁶LiD and ⁷LiD, and deuterons react with deuterons to produce neutrons, that is, neutron nuclear fusion is achieved by means of multiatom molecules, a neutron breeding reaction and a self-circulation continuous nuclear fusion reaction are formed, so that the nuclear energy can be released more easily without requiring a high temperature of more than one hundred million degrees, and the amount of the incident nuclear beam can be controlled, allowing for controllable nuclear fusion at low temperatures.

### DESCRIPTION OF THE ACCOMPANYING DRAWINGS

The accompanying drawings are included to provide a further understanding of the embodiments of the present disclosure, and constitute a part of the specification. They are used to illustrate the embodiments of the present disclosure and, together with the textual description, to explain the principles of the present disclosure. It is obvious that the drawings described below are only some embodiments of the present disclosure. For those skilled in the art, other drawings can be obtained based on these drawings without creative labor. In the accompanying figures:

FIG. 1 is a schematic diagram of the module of the nuclear fusion device according to the first embodiment of the present disclosure;

FIG. 2 is a vertical sectional view of the nuclear fusion device according to the second embodiment of the present disclosure;

FIG. 3 is a vertical sectional view of the nuclear fusion device according to the third embodiment of the present disclosure;

FIG. 4 is a top sectional view of the shallow conduit part of the nuclear fusion device according to the fourth embodiment of the present disclosure;

FIG. 5 is a side sectional view of the shallow conduit part of the nuclear fusion device according to the fourth embodiment of the present disclosure;

FIG. 6 is a flowchart of the method for controlling the nuclear fusion intensity of the nuclear fusion device according to the fifth embodiment of the present disclosure;

FIG. 7 is a flowchart of the method for controlling the nuclear fusion intensity of the nuclear fusion device according to the sixth embodiment of the present disclosure.

Among them: 100, nuclear fusion device; 110, nuclear beam generation unit; 111, ionization chamber; 112, accelerator; 120, reaction vessel; 121, inner layer; 122, outer layer; 123, base plate; 124, cylinder; 130, thermal energy output system; 131, cooling conduit; 132, vapor conduit; 133, one-way opening valve; 134, cooling fluid conduit; 140, electrical energy output system; 141, terminal; 150, temperature sensor; 160, shallow conduit; 161, inner layer of shallow conduit; 162, outer layer of shallow conduit; 163, front of shallow conduit; 170, push rod; 180, electric heating device; 181, heater; 190, isolation plate; 200, neutron absorption layer.

### DETAILED DESCRIPTION OF THE EMBODIMENTS

It should be understood that the terminology used herein, specific structural and functional details disclosed are intended to be representative only for purposes of describing particular embodiments, and this disclosure may be embodied in many alternate forms and should not be construed as limited to only the embodiments set forth herein.

The present disclosure will be described in detail below with reference to the accompanying drawings and optional embodiments.

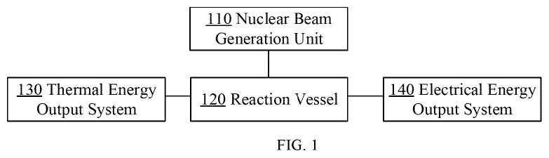

As shown in FIG. 1, as a first embodiment of the present disclosure, a nuclear fusion device is disclosed, and the nuclear fusion device 100 includes a nuclear beam generation unit 110 that emits nuclear beams, a reaction vessel 120 filled with a nuclear fusion material, a thermal energy output system 130 and an electrical energy output system 140 that respectively convert the energy generated by the nuclear fusion reaction into thermal energy and electrical energy for output. The reaction vessel 120 receives the nuclear beams, which are incident into the reaction vessel and react with the nuclear fusion material inside to produce neutrons, achieving a neutron nuclear fusion cycle reaction and releasing energy. Wherein, the nuclear beams include at least one of a triton beam with a single nucleus energy of 50 KeV-1 MeV, a deuteron beam with a single nucleus energy of 100 KeV-5 MeV, and a proton beam with a single nucleus energy of 2-10 MeV; the nuclear fusion material includes polyatomic molecules, wherein the polyatomic molecules at least include ⁶LiD and ⁷LiD.

In this embodiment, the nuclear fusion reaction mainly involves atoms in the nuclear beam reacting with the nuclear fusion material in the reaction vessel 120. The nuclear beam generation unit 110 can control the amount of nuclear beams emitted into the reaction vessel 120. The polyatomic molecules in the reaction vessel 120 at least include ⁶LiD and ⁷LiD, where deuterons react with deuterons to produce neutrons, thus achieving neutron nuclear fusion through polyatomic molecules, forming a neutron breeding reaction and a self-circulation continuous nuclear fusion reaction. No radioactive nuclei are produced, the incident ion energy is low, making it easier to release nuclear energy with higher efficiency, simpler structure, and lower cost. In the nuclear reaction, tritons naturally gain high energy upon production. Therefore, the entire nuclear reaction process does not require high temperatures, achieving controllable nuclear fusion at low temperatures.

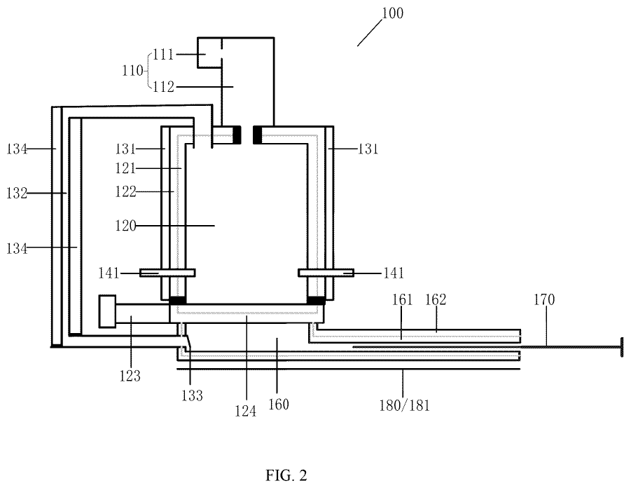

As shown in FIG. 2, as a second embodiment of the present disclosure, which further refines and improves upon the first embodiment described above, the shape of the reaction vessel 120 includes at least three types: rectangular prism, cylinder, and spherical. Taking the rectangular shape as an example, the wall of the reaction vessel 120 has two layers: an inner layer 121 and an outer layer 122. The inner layer includes a neutron reflection layer, and the outer layer includes a neutron absorption layer 200. The neutron reflection layer includes a beryllium atom ⁹Be layer, and the neutron absorption layer includes a boron atom ¹⁰B layer. The thickness of the wall of the reaction vessel 120 is greater than or equal to a thickness required to reduce a kinetic energy of neutrons to 25.3 meV. The nuclear beam generation unit 110 includes an ionization chamber 111 and an accelerator 112; the ionization chamber 111 generates positive ions and transports same to the accelerator 112, which vertically emits these positive ions onto the nuclear fusion material. The polyatomic molecules include ⁶LiD and ⁷LiD, with the weight ratios of ⁶LiD and ⁷LiD in the nuclear fusion material being 30% to 70% and 70% to 30%, respectively. The atomic nuclei of the nuclear fusion material also serve as target nuclei for the nuclear beams.

Specifically, neutrons are produced after the nuclear beams are incident onto the nuclear fusion material. These neutrons in the fusion material have reduced kinetic energy due to multiple interactions, and the neutron absorption section is increased. The thickness of the wall of the reaction vessel 120 is not less than that required to reduce the neutron kinetic energy to 25.3 meV; that is, the thickness of the wall of the reaction vessel 120 is determined by the average kinetic energy of the neutrons. When the shape, wall thickness and volume of the reaction vessel 120 are all determined, the intensity of the nuclear fusion reaction inside the reaction vessel 120 is determined by the number of neutrons, which in turn is determined by the quantity of the nuclear beams and the fusion material. Controlling the acceleration voltage in the accelerator 112 determines the nuclear average energy E_{N} in the nuclear beams, at which point the intensity of the nuclear beams depends only on the nuclear number average density n_{N} in the accelerator 112. The nuclear number average density n_{N} is determined by the atomic number density in the ionization chamber 111 and the voltage therein. Controlling the atomic number density in the ionization chamber 111 and the voltage in the accelerator 112 thus controls both the nuclear beam and the nuclear average energy E_{N}.

It should be noted that the section for producing neutrons after collision between nuclei in the nuclear beam and target nuclei depends on the average energy E_{N}. This section σ_{N} is significantly non-zero only when E_{N} falls within a certain range (E_{N1}, E_{N2}). For the selected incident nuclei and target nuclei, (E_{N1}, E_{N2}) is determined, and σ_{N} reaches a maximum value when E_{N} equals a specific value E_{N0}; the acceleration voltage in the accelerator 112 is selected such that E_{N} falls within the range (E_{N1}, E_{N2}).

Furthermore, the reaction vessel 120 includes a base plate 123, the base plate includes a valve, the size of the valve opening is automatically controlled based on input signals primarily generated from temperature changes; the nuclear fusion device 100 also includes a shallow conduit 160 and a push rod 170, the shallow conduit 160 is connected to the valve opening, and the solution in the reaction vessel 120 flows through the valve opening into the shallow conduit, and under an action of the push rod, the solution in the shallow conduit flows back into the reaction vessel 120; an electric heating device 180 is provided under the shallow conduit 160, the electric heating device 180 is capable of heating the solidified solution, and the electric heating device 180 includes a heater 181; wherein the solution is the nuclear fusion material in a molten state, and the push rod 170 is made of ⁹Be.

Generally, the internal height of the reaction vessel 120 is 62 mm, with an inner diameter of 64 mm, a volume of 200 mL, and a wall thickness of 40 mm. The neutron reflection layer made of ⁹Be has a thickness of 20 mm, and the neutron absorption layer made of ¹⁰B also has a thickness of 20 mm. The base plate 123 of the reaction vessel 120 is a valve capable of automatically opening, closing or opening an appropriate opening according to needs. Connected to the bottom is a cylinder 124 with an inner diameter of 64 mm, which communicates with 50 shallow conduits 160 with a width of 10 mm, a depth of 1.1 mm, a length of 400 mm, arranged horizontally with a rectangular section. After opening the valve, the melt in the reaction vessel 120 flows into these shallow conduits 160. The shallow conduits 160 are made of 10B with a thickness of 5 mm. At the end of each shallow conduit 160, a melt push rod 170 is provided that matches the conduit with rectangular section, the push rod 170 can push the melt back into the reaction vessel 120. Around the shallow conduits 160, there is a neutron absorption layer 200. The heating resistance wires are provided around the cylinder 124 below the bottom plate 123 and shallow conduits 160. Outside the neutron absorption layer, a steel casing is provided, and the two are separated by 5 cm. In this gap and the cooling conduit 131 connected thereto, the cooling water circulates under the action of a pump. The shallow conduit 160 includes an inner layer of shallow conduit 161 made of ⁹Be connected to the bottom conduit of the reaction vessel 120, and an outer layer of shallow conduit 162 made of ¹⁰B connected to the bottom conduit of the reaction vessel 120.

The base plate 123 of the reaction vessel 120 is a valve capable of opening or closing, with the size of the opening automatically controlled by input signals. A cooling conduit 131 is arranged around the reaction vessel 120. The molten fusion material, or melt, can flow out through the opening, reducing the amount of fusion material and weakening the fusion reaction. Shutting down the accelerator 112 and completely releasing the fusion material stops the fusion reaction. Once the reaction vessel 120 is filled with fusion material, turning on the accelerator 112 and introducing the nuclear beam initiates the fusion reaction. Connected to the opening are multiple shallow conduits 160 with a depth of d, where d represents the maximum depth at which the fusion reaction cannot continue in the shallow conduits 160. The number of the shallow conduits 160 is determined as needed. The melt can also flow back into the reaction vessel 120 from the shallow conduits 160 under the push of the push rod 170 made of beryllium atoms ⁹Be, increasing the amount of fusion material in the reaction vessel 120, enhancing the reaction, and raising the temperature. Controlling the intensity of the nuclear beam and the quantity of fusion material controls the intensity of the nuclear reaction.

When the fusion reaction causes the temperature of the fusion material to exceed its melting point, vapor of the fusion material is produced; upon reaching boiling point, a large amount of vapor is generated. After the vapor flows out, the amount of fusion material decreases, and the reaction intensity lowers. This vapor flows from the vapor outlet above the reaction vessel 120 into the vapor conduit 132, which connects to the cylinder 124 below the base plate 123 of the reaction vessel 120. The vapor conduit 132 is made of ¹⁰B, and outside the vapor conduit 132 is the cooling fluid conduit 134, and the fluid circulates in the cooling fluid conduit 134 to cool the vapor of the fusion material in the vapor conduit 132 back into liquid form. The outlet of the vapor conduit 132 is located on the cylinder 124 below the base plate 123 of the reaction vessel 120, equipped with a one-way opening valve 133. After being cooled into liquid, the fusion material follows the conduit, pushes open the one-way valve, and flows into the cylinder 124 below the base plate 123 of the reaction vessel 120, eventually is pushed back into the reaction vessel 120. The one-way valve prevents the melt in the cylinder 124 from flowing towards the vapor conduit 132.

Specifically, after being accelerated to a set energy by the linear accelerator 112, the nuclear beam is incident vertically onto the nuclear fusion material, initiating a nuclear reaction with the fusion material, releasing neutrons. These neutrons trigger a series of nuclear reactions in the fusion material, releasing neutrons and other particles along with nuclear energy. The main nuclear reactions involving the triton t beam, which release neutrons, are as follows:

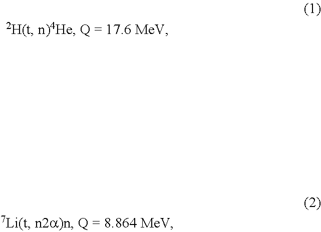

The main nuclear reactions involving the deuteron d beam, which release neutrons and protons, are as follows:

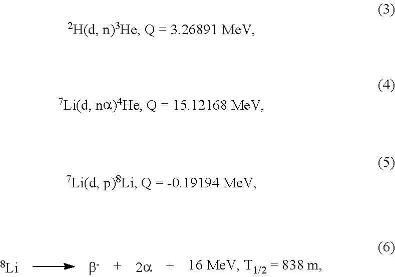

The main nuclear reactions involving the proton p beam, which release neutrons, are as follows:

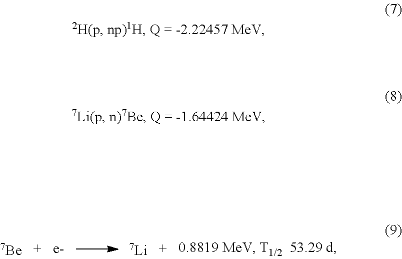

The main fusion reactions caused by neutrons are as follows:

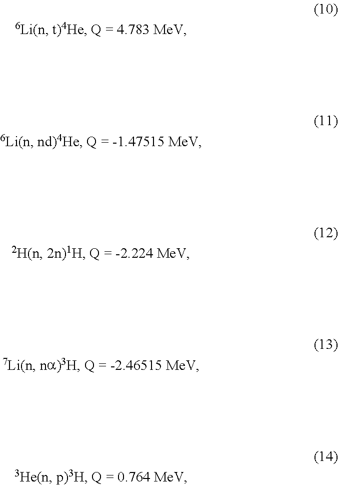

From reactions (1) to (14), it is evident that these reactions form a cyclical and sustainable process. For instance, from reactions (10) and (2), it can be seen that as long as there is an appropriate ratio and sufficient quantity of ⁶Li and ⁷Li, along with an appropriate number of neutrons, the reaction can undergo multiple cycles. Consequently, the nuclear energy released far exceeds the initial electrical energy input required to produce neutrons.

Beryllium has a larger reflection section for neutrons, especially low-energy neutrons, with σ(10 μeV)=120 barns, so ⁹Be is used to make the neutron reflection layer. There is a neutron absorption layer on the outer surface surrounding the reaction vessel 120. Boron has a large absorption section for neutrons, with σ(10 μeV)=2×10\hat{ }5 barns, so ¹⁰B is used to make the neutron absorption layer, and the relevant reactions are as follows:

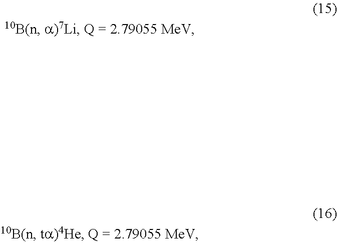

In the manner described above, by filling the reaction vessel 120 with the fusion material of ⁶LiD and ⁷LiD in proportion, activating the accelerator 112, and introducing the nuclear beam, nuclear energy is released. Conversely, when the accelerator 112 is turned off and the fusion material flows out of the reaction vessel 120, the nuclear reaction ceases.

Generally, the thermal energy output system 130, where the thermal energy is produced by the nuclear reaction, consists of a gap between the neutron absorption layer and the outer shell layer, a cooling conduit 131 that connects to this gap, a cooling fluid within the conduit, and a power device (such as push rod 170 and one-way opening valve 133) that drives the circulation of this fluid. The electrical energy output system 140 includes a direct current power supply, electrical appliances, and conductor terminals 141 connected to the positive and negative electrodes of the direct current power supply at two points opposite each other inside the reaction vessel 120, which allows the positive ions and electrons produced by the nuclear reaction to flow through the electrical appliances to the negative and positive electrodes of the power supply, respectively, thereby outputting electrical energy. In the reaction vessel 120, two points opposite each other on a diameter are respectively connected to the positive and negative electrodes of a 100-volt DC power supply by wires and electrical appliances connected in series, so that electrons and positive ions generated by fusion in V flow to the positive and negative electrodes of the DC power supply respectively.

After fabricating this nuclear fusion device 100 in the aforementioned manner, the acceleration voltage and deuterium ion current are adjusted to 200,000 volts and 50 microamperes, respectively, and the deuterium ions are vertically incident into the container already filled with ⁶LiD, ⁷LiD and ⁹Be according to the above ratio. Neutron breeding and various reactions (1) to (32) occur within the fusion material, releasing nuclear energy which is then converted into thermal energy and electrical energy for distribution.

Additionally, the aforementioned nuclear fusion material can include polyatomic molecules such as ⁶LiD, ⁷LiD, and ⁹Be. The weight ratios of ⁶LiD, ⁷LiD, and ⁹Be in the nuclear fusion material can be 20% to 60%, 60% to 20%, and 20% to 40%, respectively. The main nuclear reactions related to beryllium are as follows:

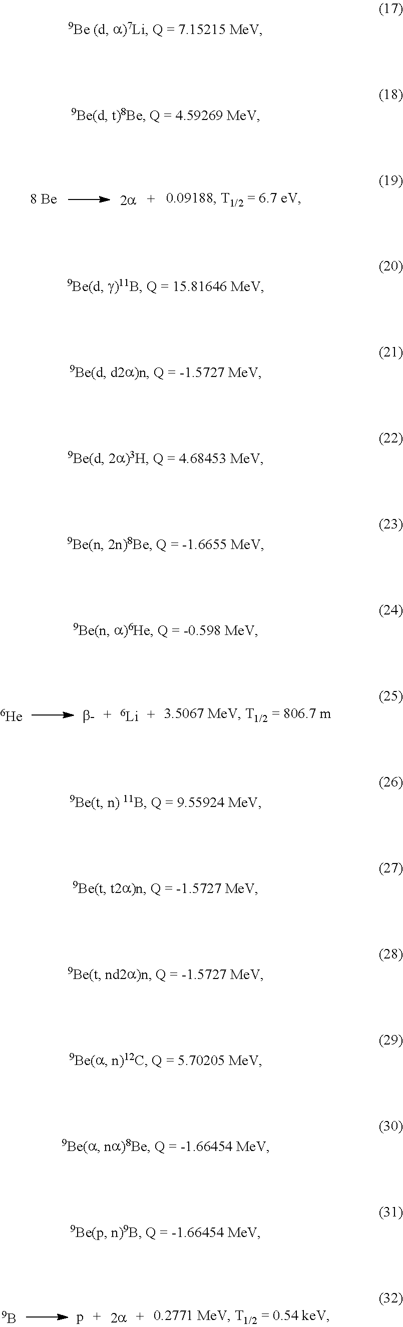

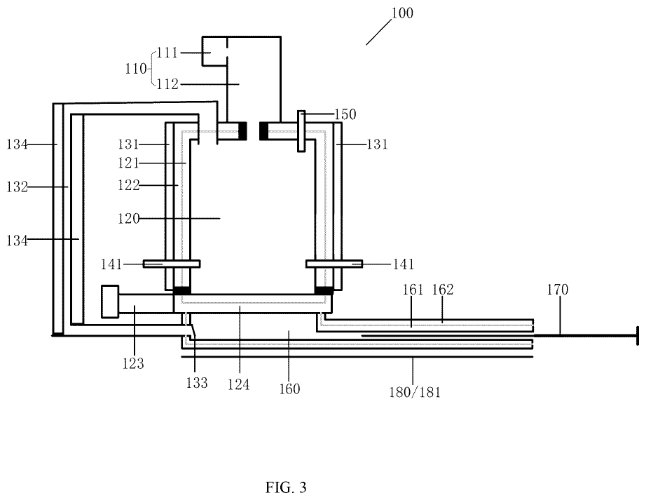

As shown in FIG. 3, which illustrates a third embodiment of the present disclosure, further improvements are made to any of the previous embodiments. Taking the second embodiment as an example, the nuclear fusion device 100 includes a temperature sensor 150. The temperature sensor 150 is installed above the reaction vessel 120 and is used to measure the boiling point of the solution inside the reaction vessel 120. The temperature sensor 150 is connected to the accelerator 112 and the valve. Based on the comparison between the measured boiling point temperature and a preset temperature, the electrical signals are sent to the accelerator 112 and the valve to control the amount of nuclear beam incident into the reaction vessel 120 by the accelerator 112 or to control the opening or closing of the valve, thereby controlling the intensity and temperature of the nuclear reaction.

Above the reaction vessel 120, a temperature sensor 150 is installed, the temperature sensor 150 converts measurement results into corresponding electrical signals. These signals are transmitted to both the nuclear beam control system and the valve control system. The nuclear beam control system primarily consists of the accelerator 112, while the valve control system involves the base plate 123 of the reaction vessel 120 and the one-way opening valve in the cooling conduit 131, which controls the temperature of the fusion reaction below its boiling point TO. When the temperature approaches TO, the temperature control device outputs the signals to the systems controlling the intensity of the nuclear reaction and its on/off status, reducing the amount of the beams and fusion material, thereby decreasing the intensity and temperature of the nuclear reaction. When the temperature of the fusion material drops below 700° C., the valve opens, the fusion material from the shallow conduit 160 is pushed back into the reaction vessel 120, enhancing the nuclear beam and thus intensifying the fusion reaction and raising the temperature.

The temperature sensor 150 that measures temperatures through infrared and converts the measurement results into corresponding electrical signals is installed above the reaction vessel 120. The electrical signals are transmitted to the nuclear beam control system to control the size of the nuclear beam output by the accelerator 112, and output to the valve control system to control the opening of the valve. When the fusion temperature approaches 1000° C., the temperature control device automatically starts, and the nuclear beam automatically decreases, and at the same time, the valve opening is partially opened, the fusion material in the reaction vessel 120 is reduced, the nuclear fusion reaction is weakened, and the temperature is reduced; when the temperature reaches or exceeds 1000° C., the nuclear beam decreases to zero, the fusion material completely flows out and is dispersed into the shallow conduits 160, and the nuclear fusion reaction stops. When the temperature drops to 700° C., the nuclear beam is increased again to the maximum, the valve opens, and the molten fusion material in the conduit is pushed back into the reaction vessel 120 by the push rod 170 to strengthen the reaction.

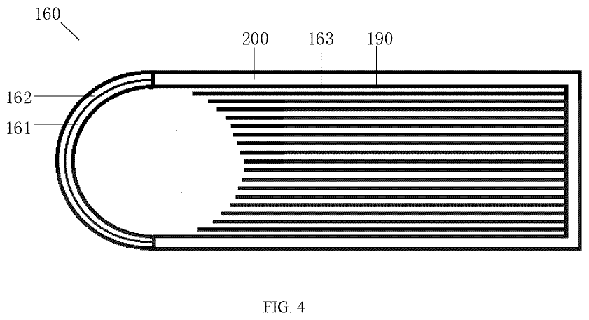

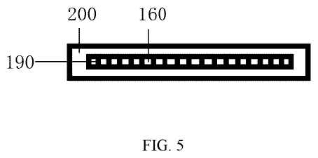

In FIG. 4 and FIG. 5, which illustrate a fourth embodiment of the present disclosure, further improvements are made to any of the previous embodiments. Taking the third embodiment as an example, as illustrated in FIG. 3 to FIG. 5, the nuclear fusion device 100 includes an isolation plate 190, and multiple isolation plates 190 are provided. From the front of the shallow conduit 163, it is directly observable that when the temperature sensor 150 measures a boiling point temperature greater than or equal to a preset temperature, the isolation plates 190 are inserted into the reaction vessel 120 to a predetermined depth. When the measured boiling point temperature is less than the preset temperature, the inserted isolation plates 190 are pulled out. The isolation plates 190 are made from ¹⁰B.

The isolation plates 190 made of ¹⁰B are inserted into the molten fusion material, with insertion depth determined as needed. The deeper the insertion is, the more the fusion reaction is weakened; if they are fully inserted, the fusion reaction stops. This is because ¹⁰B can significantly absorb neutrons, and the deeper the insertion, the more neutrons involved in fusion reactions decrease; complete insertion lowers the neutron count below the threshold for sustained reaction. When the temperature approaches TO, inserting the 10B isolation plates 190 to an appropriate depth reduces the reaction intensity. When the fusion material temperature drops below 700° C., pulling out the isolation plates 190 strengthens the reaction, raises the temperature, and thus makes the nuclear fusion intensity controllable.

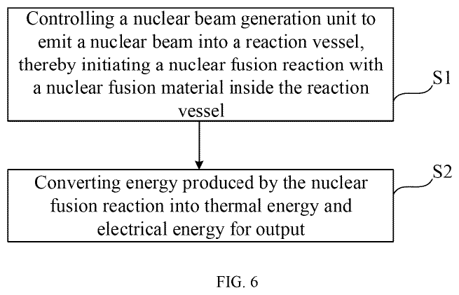

As shown in FIG. 6, illustrating a fifth embodiment of the present disclosure, a method for controlling nuclear fusion intensity is disclosed, applicable to control the nuclear fusion intensity of the nuclear fusion device described in any of the above embodiments. The control method includes the following steps:
S1: controlling a nuclear beam generation unit to emit a nuclear beam into a reaction vessel, thereby initiating a nuclear fusion reaction with a nuclear fusion material inside the reaction vessel;
S2: converting the energy produced by the nuclear fusion reaction into thermal energy and electrical energy for output.

In this embodiment, the nuclear beam generation unit emits a nuclear beam into the reaction vessel. The atoms in the nuclear beam interact with the fusion material in the reaction vessel to produce a nuclear fusion reaction. The nuclear fusion reactions by the polyatomic molecules proposed in this disclosure generates no radioactive nuclei; the incident ion energy is low, nuclear energy is easier to be released, and the nuclear fusion can be controlled.

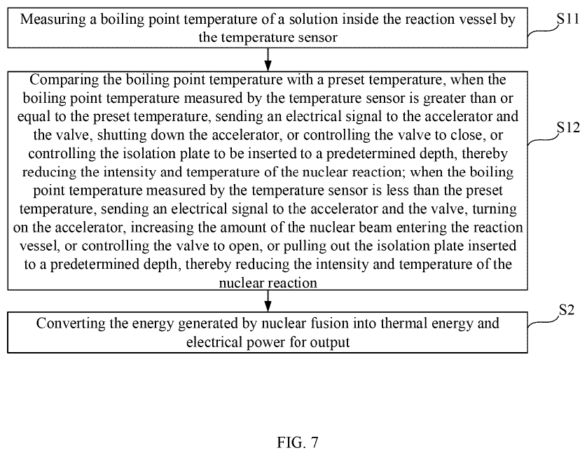

As shown in FIG. 7, illustrating a sixth embodiment of the present disclosure, which further refines and perfects the fifth embodiment, the nuclear fusion device includes a temperature sensor and isolation plates. The step S1 includes:
S11: measuring a boiling point temperature of the solution inside the reaction vessel by the temperature sensor;
S12: comparing the boiling point temperature with a preset temperature, when the boiling point temperature measured by the temperature sensor is greater than or equal to the preset temperature, sending an electrical signal to the accelerator and the valve, shutting down the accelerator, or controlling the valve to close, or controlling the isolation plate to be inserted to a predetermined depth, thereby reducing the intensity and temperature of the nuclear reaction; when the boiling point temperature measured by the temperature sensor is less than the preset temperature, sending an electrical signal to the accelerator and the valve, turning on the accelerator, increasing the amount of the nuclear beam entering the reaction vessel, or controlling the valve to open, or pulling out the isolation plate inserted to a predetermined depth, thereby reducing the intensity and temperature of the nuclear reaction.

To further enhance the control over the nuclear fusion intensity, during the fusion reaction, the temperature within the reaction vessel is measured. When the fusion temperature approaches 1000° C., the temperature control device automatically starts, and the nuclear beam automatically decreases, and at the same time, the valve opening is partially opened, the fusion material in the reaction vessel is reduced, the nuclear fusion reaction is weakened, and the temperature is reduced; when the temperature reaches or exceeds 1000° C., the accelerator reduces the nuclear beam to zero, the fusion material completely flows out and is dispersed into the shallow conduits, and the nuclear fusion reaction stops. When the temperature drops to 700° C., the nuclear beam is increased again to the maximum, the valve of the base plate opens, and the molten fusion material in the conduit is pushed back into the reaction vessel by the push rod 170 to strengthen the reaction.

It should be noted that the steps outlined in this scheme are not limited to a specific sequence unless explicitly stated, meaning steps listed earlier can be executed first, later, or even simultaneously. As long as this scheme can be implemented, it should be considered as falling within the scope of protection of this disclosure. The inventive concept of this disclosure can lead to numerous embodiments; however, due to space limitations in the disclosure document, it is impossible to list them all. Therefore, under the premise of non-conflict, the various embodiments or technical features described above can be combined in any way to form new embodiments, enhancing the original technical effects.

The above content provides a detailed explanation of this disclosure in conjunction with specific optional embodiments, but it should not be interpreted as limiting the implementation of this disclosure to just these descriptions. For those skilled in the art related to this disclosure, several simple deductions or substitutions can be made without departing from the inventive concept of this disclosure, and such variations should also be considered within the scope of protection of this disclosure.

What is claimed is:

1. A nuclear fusion device, comprising:
a nuclear beam generation unit emitting a nuclear beam;
a reaction vessel filled with a nuclear fusion material, wherein the reaction vessel receives the nuclear beam emitted by the nuclear beam generation unit, the nuclear beam is incident into the reaction vessel and initiates a nuclear fusion reaction with the nuclear fusion material in the reaction vessel to generate neutrons, achieving a neutron nuclear fusion cycle reaction and releasing energy;
a thermal energy output system that converts the energy produced by the nuclear fusion reaction into thermal energy for output; and
an electrical energy output system that converts the energy produced by the nuclear fusion reaction into electrical energy for output;
wherein, the nuclear beam comprises at least one of a triton beam with a single nucleus energy of 50 KeV-1 MeV, a deuteron beam with a single nucleus energy of 100 KeV-5 MeV, and a proton beam with a single nucleus energy of 2-10 MeV; the nuclear fusion material comprises polyatomic molecules, wherein the polyatomic molecules at least comprise ⁶LiD and ⁷LiD.

2. The nuclear fusion device of claim 1, wherein a wall of the reaction vessel is provided with two layers, namely an inner layer and an outer layer, the inner layer comprises a neutron reflection layer, the outer layer comprises a neutron absorption layer, the neutron reflection layer comprises a ⁹Be layer, and the neutron absorption layer comprises a ¹⁰B layer;
wherein a thickness of the wall of the reaction vessel is greater than or equal to a thickness required to reduce a kinetic energy of neutrons to 25.3 meV.

3. The nuclear fusion device of claim 2, wherein the polyatomic molecules comprise ⁶LiD and ⁷LiD, and weight ratios of ⁶LiD and ⁷LiD in the nuclear fusion material are respectively 30% to 70% and 70% to 30%.

4. The nuclear fusion device of claim 2, wherein the polyatomic molecules comprise ⁶LiD, ⁷LiD and ⁹Be, and weight ratios of ⁶LiD, ⁷LiD and ⁹Be in the nuclear fusion material are respectively 20% to 60%, 60% to 20%, and 20% to 40%.

5. The nuclear fusion device of claim 2, wherein ⁹Be in the neutron reflection layer has a large reflection section for neutrons, with σ(10 μeV)=120 b; ¹⁰B in the neutron absorption layer has a larger absorption section for neutrons compared to that of ⁹Be in the neutron reflection layer, with σ(10 μeV)=2×10⁵ b.

6. The nuclear fusion device of claim 2, wherein the nuclear beam generation unit comprises an ionization chamber and an accelerator; the ionization chamber generates positive ions and transports same to the accelerator, and the positive ions is vertically incident onto the nuclear fusion material by the accelerator;
the reaction vessel comprises a base plate, the base plate comprises a valve, a size of the valve opening is automatically controlled based on input signals; the nuclear fusion device also comprises a shallow conduit and a push rod, the shallow conduit is connected to the valve opening, and a solution in the reaction vessel flows through the valve opening into the shallow conduit, and under an action of the push rod, the solution in the shallow conduit flows back into the reaction vessel; an electric heating device is provided under the shallow conduit, and the electric heating device is capable of heating a solidified solution;
wherein the solution is the nuclear fusion material in a molten state, and the push rod is made of ⁹Be.

7. The nuclear fusion device of claim 6, wherein the nuclear fusion device comprises a temperature sensor, the temperature sensor is provided above the reaction vessel to measure a boiling point of the solution inside the reaction vessel; the temperature sensor is connected to the accelerator and the valve, sends electrical signals to the accelerator and the valve based on comparison results between the boiling point temperature and a preset temperature, controls an amount of the nuclear beam incident into the reaction vessel by the accelerator, or controls the opening or closing of the valve, thereby controlling the intensity and temperature of the nuclear reaction.

8. The nuclear fusion device of claim 7, wherein the nuclear fusion device comprises an isolation plate, when the temperature sensor measures a boiling point temperature greater than or equal to the preset temperature, the isolation plate is inserted into the reaction vessel to a predetermined depth, when the temperature sensor measures a boiling point temperature less than the preset temperature, the isolation plate inserted into the reaction vessel is pulled out;
wherein the isolation plate is made of ¹⁰B.

9. A method for controlling nuclear fusion intensity, used for controlling the nuclear fusion intensity of the nuclear fusion device of claim 1, comprising the following steps:
controlling a nuclear beam generation unit to emit a nuclear beam into a reaction vessel, thereby initiating a nuclear fusion reaction with a nuclear fusion material inside the reaction vessel;
converting energy produced by the nuclear fusion reaction into thermal energy and electrical energy for output.

10. The method for controlling nuclear fusion intensity of claim 9, wherein the nuclear fusion device comprises a temperature sensor and an isolation plate, and the step of controlling a nuclear beam generation unit to emit a nuclear beam into a reaction vessel, thereby initiating a nuclear fusion reaction with a nuclear fusion material inside the reaction vessel comprises:
measuring a boiling point temperature of a solution inside the reaction vessel by the temperature sensor;
comparing the boiling point temperature with a preset temperature, when the boiling point temperature measured by the temperature sensor is greater than or equal to the preset temperature, sending an electrical signal to the accelerator and the valve, shutting down the accelerator, or controlling the valve to close, or controlling the isolation plate to be inserted to a predetermined depth, thereby reducing the intensity and temperature of the nuclear reaction; when the boiling point temperature measured by the temperature sensor is less than the preset temperature, sending an electrical signal to the accelerator and the valve, turning on the accelerator, increasing the amount of the nuclear beam entering the reaction vessel, or controlling the valve to open, or pulling out the isolation plate inserted to a predetermined depth, thereby reducing the intensity and temperature of the nuclear reaction.
